(19) United States
(12) Patent Application Publication
(10) Pub. No.: US 2025/0247322 A1
(43) Pub. Date: Jul. 31, 2025

(54) K-shortest paths computation in Segment Routing considering segment depth

(71) Applicant: Ciena Corporation, Hanover, MD (US)

(72) Inventors: Todd Defilippi, Redwood City, CA (US); Cengiz Alaettinoglu, Sherman Oaks, CA (US); John Wade Cherrington, Salt Spring Island (CA)

(73) Assignee: Ciena Corporation, Hanover, MD (US)

(21) Appl. No.: 18/422,932

(22) Filed: Jan. 25, 2024

(51) Int. Cl. H04L 45/12

(52) U.S. Cl. CPC H04L 45/12

(57) ABSTRACT

Systems and methods for k-shortest paths computation in Segment Routing considering segment depth include receiving a request for a path in a Segment Routing network from a first node to a second node with the path having a pruning criteria; determining a shortest path utilizing a Constrained Shortest Path First (CSPF) algorithm with a sorting criteria used as a metric in the CSPF algorithm; utilizing a modified Yen's algorithm to determine one or more additional paths based on diversions from the shortest path, wherein the modified Yen's algorithm explores the diversions based on the pruning criteria; and providing the shortest path and the one or more additional paths as a response to the request, each of the shortest path and the one or more additional paths pass the pruning criteria.

### FIELD OF THE DISCLOSURE

The present disclosure relates generally to networking and computing. More particularly, the present disclosure relates to systems and methods for k-shortest paths computation in Segment Routing considering segment depth.

### BACKGROUND OF THE DISCLOSURE

Segment Routing (SR) is a technology that implements a source routing paradigm. A packet header includes a stack of function identifiers, known as segments, which define an ordered list of functions to be applied to the packet. A segment can represent any instruction, topological, or service-based, and each segment is represented by a Segment Identifier (SID). Segment Routing is described, e.g., in Fiflsfils et al., RFC 8402, “Segment Routing Architecture,” Internet Engineering Task Force (IETF), July 2018, the contents of which are incorporated herein by reference. In Segment Routing, a path includes segments which are instructions a node executes on an incoming packet. Segment Routing works on top of either a Multiprotocol Label Switching (MPLS) network (referred to as SR-MPLS) or an Internet Protocol version 6 (IPv6) network (referred to as SRv6). In SR-MPLS, the segments are encoded as MPLS labels, and, in SRv6, the segments are encoded in a Segment Routing Header (SRH) as a list of IPV6 addresses.

### BRIEF SUMMARY OF THE DISCLOSURE

The present disclosure relates to systems and methods for k-shortest paths computation in Segment Routing considering segment depth. Conventionally, Segment Routing uses a normal Constrained Shortest Path First (CSPF) path computation algorithm which returns a single path. In some cases, if this single path requires a large number of segments, there can be a problem in terms of acceptable Maximum Segment Depth (MSD). The shortest path is useless if it cannot be encoded in an acceptable number of segments. Accordingly, the present disclosure includes an approach for enumerating multiple CSPF paths (e.g., from shorter to longer paths) until a path or k-paths are found satisfying the MSD constraint. Of note, the MSD constraint is not additive meaning it cannot be considered on a link-by-link basis as a weight or value that is added.

In various embodiments, the present disclosure includes a method having steps, an apparatus configured to implement the steps, and a non-transitory computer-readable medium storing instructions that, when executed, cause one or more processors to perform the steps. The steps are for determining a path in a Segment Routing network. The steps include receiving a request for a path in a Segment Routing network from a first node to a second node with the path having a pruning criteria; determining a shortest path utilizing a Constrained Shortest Path First (CSPF) algorithm with a sorting criteria used as a metric in the CSPF algorithm; utilizing a modified Yen's algorithm to determine one or more additional paths based on diversions from the shortest path, wherein the modified Yen's algorithm explores the diversions based on the pruning criteria; and providing a plurality of paths as a response to the request, wherein the plurality of paths include each of the shortest path and the one or more additional paths that pass the pruning criteria.

The modified Yen's algorithm can explore the diversions based on the pruning criteria by excluding a root path for a diversion if the root path does not meet the pruning criteria. The modified Yen's algorithm can explore the diversions based on the pruning criteria by (1) excluding a possible path if it extends from a root path that does not meet the pruning criteria, and (2) including another possible path that does not itself meet the pruning criteria if it extends from another root path that does meet the pruning criteria. The modified Yen's algorithm can explore the diversions based on the pruning criteria by examining previous paths to find root paths, spur nodes, and spur paths, to combine into a total path; excluding any of the root paths in the examining when a corresponding root path does not meet the pruning criteria; and adding the total path from the examining to a heap based on the sorting criteria.

The pruning criteria can be Maximum Segment Depth (MSD). The providing the shortest path and the one or more additional paths can include providing the shortest path and the one or more additional paths in a sorted order by the sorting criteria. The first node can be a source, the second node can be an intermediate node, and the request can further include a destination, wherein the steps can further include performing the determining and the utilizing from the second node to the destination, such that there is a first path computation from the source to the intermediate node and a second path computation from the intermediate node to the destination; maintaining a heap to add a path from each of the first path computation and the second path computation based on the pruning criteria.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a network including network elements illustrating example paths.

FIG. 2 is a flowchart of a process for a k-shortest paths computation in Segment Routing considering a pruning criteria (e.g., MSD).

FIG. 3 is a block diagram of an example processing device, such as for a Path Computation Element (PCE).

### DETAILED DESCRIPTION OF THE DISCLOSURE

Again, the present disclosure relates to systems and methods for k-shortest paths computation in Segment Routing considering segment depth. SR-MPLS and SRv6 use a list of segment IDs that are passed in the MPLS or IPv6 header of a packet. A longer segment list takes longer to insert into the packet headers by the head-end routers. As a result, devices (network elements) may impose a MSD that they support without sacrificing the rate of packet transmission (line rate); this number is usually somewhere in the range of 3 to 5 segments for low-end commodity chips or 4 to 7 segments for most commodity chips. Attempting to set up a segment routed path with a longer segment list on such a network will result in the paths not getting set up.

Thus, the MSDs of head-end nodes need to be considered by a Path Computation Element (PCE) while computing paths. That is, for a head-end node, the PCE should only compute intended paths that can be compressed into SID lists shorter than the head-end node's MSD. How the PCE learns MSDs is typically distributed in various routing protocols. The intended path is typically computed by a PCE using CSPF, however the compression logic is typically done by relying on regular SPF. Conventionally, it is not possible to use the MSD as a CSPF constraint. The present disclosure relies on enumerating multiple CSPF paths (from shorter to longer order) until a path (or k-paths) satisfying the MSD constraint is generated. Note, a longer path may compress into a shorter SID list. However, adding more links and/or nodes to the end of a path cannot shorten the SID list.

### Segment Routing Overview

A particular attraction of Segment Routing is that it obviates the need to install and maintain any end-to-end (e2e) path state in the core network. Only the ingress node for a particular flow needs to hold the segment stack, which is applied as the header of every packet of that flow, to define its route through the network. This makes Segment Routing particularly suited to control by the Software Defined Networking (SDN) model.

Segment Routing can be directly applied to MPLS with no change in the forwarding plane. A segment is encoded as an MPLS label. An ordered list of segments is encoded as a stack of labels. The segment to process is on the top of the stack. Upon completion of a segment, the related label is popped from the stack. Segment Routing can also be applied to the IPV6 architecture, with a new type of routing extension header—for example, RFC 8754, “IPv6 Segment Routing Header (SRH),” March 2020, the contents of both are incorporated by reference. A segment is encoded as an IPV6 address. An ordered list of segments is encoded as an ordered list of IPV6 addresses in the routing extension header. The Segment to process at any point along the path through the network is indicated by a pointer in the routing extension header. Upon completion of a segment, the pointer is incremented. Segment Routing can also be applied to Ethernet, e.g., IEEE 802.1 and variants thereof. There are various benefits asserted for Segment Routing, including, for example, scalable end-to-end policy, easy incorporation in IP and SDN architectures, operational simplicity, a balance between distributed intelligence, centralized optimization, and application-based policy creation, and the like.

In loose source routing such as Segment Routing, a source node chooses a path or is provided a path by an SDN controller or PCE and encodes the chosen path in a packet header as an ordered list of segments. The rest of the network executes the encoded instructions without any further per-flow state. Segment Routing provides full control over the path without the dependency on network state or signaling to set up a path. This makes Segment Routing scalable and straightforward to deploy. Segment Routing natively supports both IPV6 (SRv6) and MPLS (SR-MPLS) forwarding planes and can coexist with other transport technologies, e.g., Resource Reservation Protocol (RSVP)-Traffic Engineering (RSVP-TE) and Label Distribution Protocol (LDP).

In Segment Routing, a path includes segments which are instructions a node executes on an incoming packet. For example, segments can include forwarding the packet according to the shortest path to the destination, forwarding through a specific interface, or delivering the packet to a given application/service instance. Each Segment can be represented by a Segment Identifier (SID). Note, we may use the terms segment and SID interchangeably herein, and those skilled in the art will appreciate a segment is the actual pair of nodes and associated interfaces in the network whereas the SID is an identification thereof. SIDs are allocated from a Segment Routing Global Block (SRGB) with domain-wide scope and significance, or from a Segment Routing Local Block (SRLB) with local scope. The SRGB includes the set of global segments in the Segment Routing domain. If a node participates in multiple SR domains, there is one SRGB for each SR domain. In SRv6, the SRGB is the set of global SRv6 SIDs in the Segment Routing domain.

A segment routed path is encoded into the packet by building a SID stack or list that is added to the packet. These SIDs are popped by processing nodes, and the next SID is used to decide forwarding decisions. A SID can be one of the following types: an adjacency SID, a prefix SID, a node SID, a binding SID, and an anycast SID. Each SID represents an associated segment, e.g., an adjacency segment, a prefix segment, a node segment, a binding segment, and an anycast segment.

An adjacency segment is a single-hop, i.e., a specific link. A prefix segment is a multi-hop tunnel that can use equal-cost multi-hop aware shortest path links to reach a prefix. A prefix SID can be associated with an IP prefix. The prefix SID can be manually configured from the SRGB and can be distributed by Open Shortest Path First (OSPF) or Intermediate System-Intermediate System (ISIS). The prefix segment steers the traffic along the shortest path to its destination. A node SID is a special type of prefix SID that identifies a specific node. It is configured under the loopback interface with the loopback address of the node as the prefix. A prefix segment is a global segment, so a prefix SID is globally unique within the segment routing domain. An adjacency segment is identified by a label called an adjacency SID, which represents a specific adjacency, such as egress interface, to a neighboring router. The adjacency SID is distributed by ISIS or OSPF. The adjacency segment steers the traffic to a specific adjacency.

A binding segment represents a Segment Routing policy. A head-end node of the Segment Routing policy binds a Binding SID (BSID) to its policy. When the head-end node receives a packet with an active segment matching the BSID of a local Segment Routing Policy, the head-end node steers the packet into the associated Segment Routing Policy. The BSID provides greater scalability, network opacity, and service independence. Instantiation of the Segment Routing Policy may involve a list of SIDs. Any packets received with an active segment equal to BSID are steered onto the bound Segment Routing Policy. The use of a BSID allows the instantiation of the policy (the SID list) to be stored only on the node or nodes that need to impose the policy. The direction of traffic to a node supporting the policy then only requires the imposition of the BSID. If the policy changes, this also means that only the nodes imposing the policy need to be updated. Users of the policy are not impacted. The BSID can be allocated from the local or global domain. It is of special significance at the head-end node where the policy is programmed in forwarding.

An anycast segment is a type of prefix segment that represents an anycast group. An anycast segment/SID is used for policies or protection. When forwarding traffic to an anycast SID, a node processing the forwarding will pick a device from the anycast group, which is the closest. If the closest device from the anycast group goes away, traffic will automatically switch to the next closest device in the anycast group. An anycast SID also enables load balancing and Equal Cost Multipath (ECMP).

Segment Routing Traffic Engineering (SR-TE) provides a mechanism that allows a flow to be restricted to a specific topological path, while maintaining per-flow state only at the ingress node(s) to the SR-TE path. SR-TE uses a “policy” to steer traffic through the network. An SR-TE policy path is expressed as a list of segments that specifies the path, called a segment ID (SID) list. SR-TE can use the Constrained Shortest Path First (CSPF) algorithm to compute paths subject to one or more constraint(s) (e.g., link affinity) and an optimization criterion (e.g., link latency). An SR-TE path can be computed by a head-end of the path whenever possible (e.g., when paths are confined to single IGP area/level) or at a Path Computation Element (PCE) (e.g., when paths span across multiple IGP areas/levels).

### Example Network

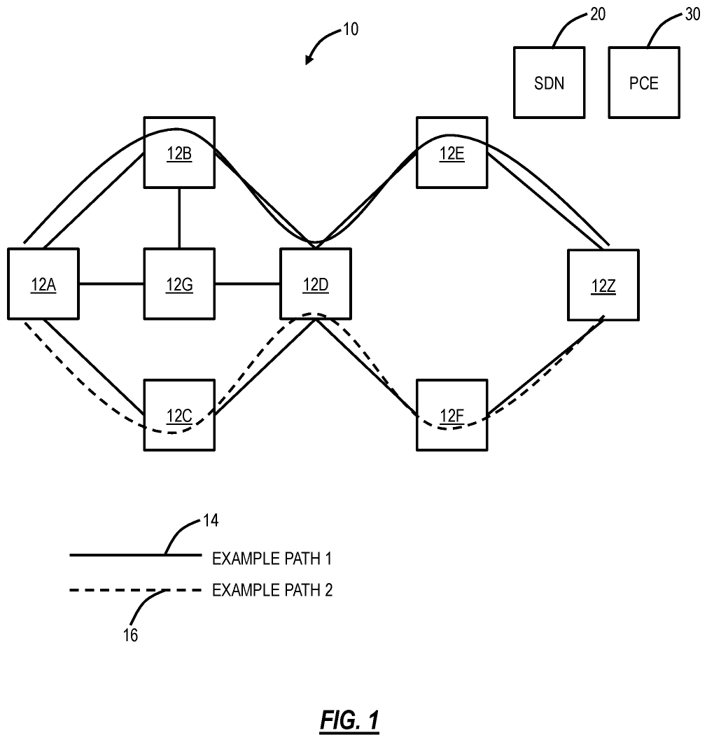

FIG. 1 is a network diagram of a network 10 including network elements 12A, 12B, 12C, 12D, 12E, 12F, 12G, 12Z illustrating example paths 14, 16. As described herein, the network elements 12 can be nodes, switches, routers, etc. implementing Segment Routing. Of course, the network 10 is presented for illustration purposes and those skilled in the art will recognize typical networks can include more nodes (network elements). Assume, for illustration purposes, there is a desire to provide a path between the network elements 12A, 12Z, and assume there is a CSPF path computation from the network elements 12A, 12B, 12D, 12E, 12Z, i.e., the path 14. This CSPF path computation can be performed by an SDN controller 20, a PCE 30, or the like. The path 14 is then converted to segments, and, for the sake of illustration, assume the path takes four segments, but the network element 12A has an MSD of three. Now, the path 14 is the constrained shortest path and it is the single path returned by the SDN controller 20, the PCE 30, etc. However, this path 14 cannot be implemented due to the MSD limitations of the network element 12A.

The path 16 may not be the constrained shortest path, but it may only require three segments or less. The present disclosure addresses these issues-how to get k-shortest paths based on non-additive constraints such as MSD.

### PCE

The PCE 30 is a processing device that handles traffic engineering in Segment Routing. The official definition of a PCE is an entity (component, application, or network node) that is capable of computing a network path or route based on a network graph and applying computational constraints. The PCE 30 is responsible for doing the path computation and then sending an appropriate segment list (i.e., a label-stack of SID labels) to the head-end node. Then the head-end node pushes those segments list labels on the packets. Note, the PCE 30 can be a server, an application, a management system, a controller, etc.

Using k-Shortest CSPF

By default, conventional path computation in Segment Routing uses a normal CSPF algorithm, which returns just a single path. As described herein, if this single path requires a large number of segments, then we have a problem. The shortest path calculated is useless if we cannot encode it in an acceptable number of segments. The single path from the CSPF was the shortest path (in terms of the metric used for interfaces in the network), and we stopped once we got that shortest path from S (source) to D (destination). In this case, we would prefer a longer path that passes the MSD requirement over the shortest path. We may still prefer the shortest path among the paths that satisfy the MSD requirement.

We can look at multiple paths by using a k-shortest path algorithm (k is an integer greater than one). As implied by the name, the k-shortest algorithm gives the k shortest paths between two nodes, rather than just the one absolute shortest path between them. Given these k results from the CSPF, we can look at them starting with the shortest and see if any of them pass our MSD restriction; the shortest such path that does pass is the one we can choose as the overall result for our path calculation. Note that if the shortest path succeeds, great; but if not, then we look at the second shortest, then the third shortest, and so on; in the end, if we do find a path, it will be the shortest path given the CSPF constraints and the MSD restriction.

### Optimizations

By definition, a k-shortest CSPF computation will take longer to run than a 1-shortest CSPF computation. For a 1-shortest CSPF, once we find a path from S to D, we know it has to be the shortest, so we are done. For k-shortest, the path computation has to keep going until we find k such paths from S to D. In the meantime, we are exploring a variety of paths and subpaths that meander from what our 1-shortest path would be. There have been a number of implementations that have looked at the most efficient way of doing this; here we will look at a rough adaptation of Yen's algorithm. Yen's algorithm is described in Yen, Jin Y. “Finding the k shortest loopless paths in a network.” management Science 17.11 (1971): 712-716, the contents of which are incorporated by reference.

The following pseudocode is an implementation of Yen's algorithm to find k-shortest paths from a source(S) to destination (D) in a network which is represented by a Graph having edges for network elements 12 and vertices for links between the network elements 12.

### A[0]=RegularCSPF(Graph, S, D);

### if (A[0]==NULL)

return;

### Heap=[ ];

for (k=1 to K) {
for (i=0 to size (A[k−1])−2) {//for every node from the first to the next to last in the previous path
   spurNode=A[k−1].node (i);
   rootPath=A[k−1].nodes (0,i);
   removeEdges=<for any previous path who also contains the root path, add the next node in that path to this set>
   Graph.remove(removeEdges);
   spurPath=RegularCSPF(Graph, spurNode, D);
   if (spurPath==NULL)
      continue;
   totalPath=append(rootPath, spurPath);
   if (Heap.contains(totalPath)==false)
      Heap.add(totalPath);
   Graph.restore(removeEdges);
}
if (Heap.empty ( ))
   return;
Heap.sort( );
A[k]=Heap.pop( );
   }

Yen's algorithm uses two lists, i.e., list A (A[0] to A[k] in the above) (permanent shortest paths from source to destination-chronologically ordered) and a second list denoted as a heap (tentative/candidate shortest paths). At first you have to find the 1st shortest path from the source to destination using any well-suited shortest path algorithm (e.g., Dijkstra). Then the Yen algorithm exploits the idea that the k-th shortest paths may share edges and sub-paths (path from source to any intermediary nodes within the route) from (k−1)-th shortest path. Then you have to take (k−1)th shortest path and make each node in the route unreachable in turn, i.e., rub off particular edge that goes to the node within the route. Once the node is unreachable, find the shortest path from the preceding node to the destination. Then you have a new route which is created by appending the common sub-path (from source to the preceding node of the unreachable node) and adds the new shortest path from preceding node to destination. This route is then added to the heap, provided that it has not appeared in list A or the heap before. After repeating this for all nodes in the route, you have to find the shortest route in heap and move that to list A. This is repeated until there are k paths in the list A.

Also, a very simplified explanation would be that we start with the 1-shortest path, and then for subsequent paths we try to find ways to divert off of paths we have found thus far, by examining at nodes along the way of the most recent path and eliminating paths we have already taken out of those nodes from contention, to make sure what we find at that point is something new. Note that this algorithm still makes use of the 1-shortest algorithm, both to find the 0th path and to find paths from the spur node to D when we are trying to find diversions. A spur node and spur path are as defined in Yen's algorithm, namely a node from which there is a diversion and a path for the diversion, from a root path.

### Optimized Yen's Algorithm

For computational efficiency and speed, we would like to optimize this process based on our original motivation of avoiding paths whose resulting segment list exceeds the MSD. It would make sense if there were certain paths or extensions of paths that we would avoid exploring because we know those paths and any of their extensions would also result in too long of a segment list. That said, Yen's algorithm is based off of taking a previously found path and finding ways to divert off of that path.

The present disclosure includes an optimization of Yen's algorithm based on the motivation of avoiding paths whose segments lists exceed the MSD. Again, Yen's algorithm utilizes diversions off of paths to ultimately find k-shortest paths. Here, we analyze diversions to determine whether or not they will exceed the MSD, to limit the exploration. It is noted that an extension of a path with a too long segment list would itself have too long of a segment list, but a diversion off of a path with a too long segment list will not necessarily have too long of a segment list; it depends on where the diversion takes place. So, we need to be careful to not be too aggressive in avoiding certain paths. These observations are used to modify Yen's algorithm to eliminate exploration of non-viable paths.

Specifically, we avoid a path if it is an extension of a path (root path) which already has a segment list too long, while we allow exploration of diverting off of a path (the root path) within the MSD limit.

### Modified Yen's Algorithm Pseudocode

The following provides pseudocode describing Yen's algorithm modified to only explore paths that will satisfy MSD constraints.

### A=[ ];

### B[0]=RegularCSPF (Graph, S, D);

### if (B[0]==NULL)

return;

### Heap=[ ];

while (size (A)<K) {
b=size (B);
a=size (A);
for (i=0 to size (B[b−1]−2) {
   spurNode=B[b−1].node(i);
   rootPath=B[b−1].nodes(0, i);
      if (calculateSegmentList(rootPath).length( )>MSD)
      break; //Optimization: any extension of such // rootPath will also not pass MSD test
removeEdges=<for any previous path who also contains the root path, add the next node in that path to this set>
Graph.remove(removeEdges);
spurPath=RegularCSPF(Graph, spurNode, D);
   if (spurPath==NULL)
      continue;
totalPath=append(rootPath, spurPath);
if (Heap.contains(totalPath)==false)
   Heap.add(totalPath);
Graph.restore(removeEdges);
}
if (Heap.empty( ))
   return;
Heap.sort( );
B[b]=Heap.pop( );
if (calculateSegmentList (B[b])>MSD)
   continue;
A[a]=B[b];
   }

Some things to note here:

(1) We have two different arrays, A and B, in addition to the heap. B can have paths whose segment list exceeds the MSD, A cannot. The purpose of B is to continue to find the shortest paths from S to D in order, by finding diversions of previous paths, regardless of the length of the resulting segment list for that path. The purpose of A is to only accept those paths whose resulting segment list is within the MSD. A is the result set of the modified Yen's algorithm.

(2) When we are looking for diversions from previous paths, it all depends on where we start our diversion.

(2a) If the root path results in a segment list that already exceeds the MSD before we use that root path in constructing a diversion, any such diversion using that root path will also result in a path whose segment list exceeds the MSD. So, there is no point in looking at any diversion using that root path, or any diversions using longer root paths for the same previous path, if the root path segment list exceeds the MSD. We save time by not going down that road.

(2b) If the root path does not result in a segment list that exceeds the MSD, it is possible that one or more diversions using that root path will also result in paths whose segment list does not exceed the MSD. This is the case even if the previous path we are inspecting to create the root path itself results in a segment list that exceeds the MSD. Its diversions might actually work even though it (the previous path) did not, so we need to look into those diversions.

### Ordered Inclusion

Up until this point, path computation has been treated as a single CSPF computation, i.e., S to D. However, there can be paths whose constraints contain an ordered list of one or more nodes or interfaces they must traverse along the way, i.e., ordered inclusions. When this happens, if a path from A to C must pass through B, we now actually need to do two separate CSPF computations, one from A to B and one from B to C; we then combine the two resulting paths to get the overall path; if there are multiple intermediate nodes that must be traversed, then we end up with multiple such CSPFs, with the results all being combined in order.

For a 1-shortest CSPF, each CSPF gives a single path as a result, so we are always combining one path with another one path, so it is just appending the latter to the former. If the CSPF computations are k-shortest CSPFs, we now end up with a set of k paths that needs to be combined with another set of k paths, giving k\hat{ }2 possible combinations. We want to keep this number from exploding to k\hat{ }3 or k\hat{ }4 due to any additional combinations, so each combination needs to police its own results to make sure only k paths make it out. Additionally, it needs to make sure that the k shortest paths that make it out do not have resulting segment lists that exceed the MSD; it makes no sense to pass through a path we will not accept in the end, and it makes even less sense to allow for later combinations to add on to such a path. Lastly, just like the result of the single k-shortest CSPF should give us the shortest paths matching our criteria, so must the combination give us the shortest paths, so we have to make sure the acceptable results are sorted and that only the k shortest such paths are returned.

The following pseudocode illustrates the approach

### Heap=[ ];

for (path1 in pathSet1) {
for (path2 in pathSet2) {
   totalPath=append (path1, path2);
   if (calculateSegmentList (totalPath).length( )>MSD)
      continue;
   Heap.add (totalPath);
}
   }
   for (k=0 to K) {
A[k]=Heap.pop ( );
   }

### Generalization

Thus far, we have been looking at this in the context of making sure the resulting segment lists do not exceed the MSD. That has been why we are getting k shortest paths instead of one, that has been how we have pruned off paths at the CSPF level, and it has also been how we pruned off paths at the CSPF combination level. In particular, in the modified Yen's algorithm, MSD can be referred to as a pruning criteria, i.e., we are using the pruning criteria to determine whether or not to ignore a path for purposes of diversion and exploration in Yen's algorithm. For example, if a path does meet the MSD requirements then the path is said to meet the pruning criteria, otherwise the path does not meet (or fails to pass) the pruning criteria. Other approaches to a pruning criteria are also contemplated, instead of MSD (e.g., delay bound or latency).

But there might be other such restrictions that the caller of the path computations wants to impose on their resulting path. They might want to limit it to paths below a certain total metric cost; note this is different than just sorting the paths to get those with the shortest metric; it is explicitly forbidding paths over a certain metrics. The caller might also want limitations on other measurements of the path, such as its overall latency; this one is especially important in real-time applications where a path has a hard limit on how much latency it can impose. Given these other possible applications, we can generalize the way we applied the MSD cutoff throughout our process to be a generic pruning criteria; one implementation may be to check the resulting segment list length against the MSD, but another might be to check the resulting overall path latency against a latency limit. If a path fails to pass the pruning criteria at any point where it is applied, we do not accept that path for continued use at the application point.

Additionally, thus far, we have ambiguously used the term “metric” to describe which metric the individual CSPFs have used to determine how we define “shortest” in 1-shortest and k-shortest, and how we also define it in terms of sorting paths during the combination phase. We should make note that there are different possible metrics that the caller could use in these situations: Interior Gateway Protocol (IGP) metric, Traffic Engineering (TE) metric, latency, number of hops, etc. All are acceptable in terms of the 1-shortest CSPF used at the lowest level, the k-shortest CSPF used above that, and the combining used above that, as long as the same metric type is used consistently throughout the process.

Note that it is not necessary that the metric type used in the pruning is the same as that used in the sorting. Network design might still mean we prefer TE metric for the sorting, based on the operator choosing TE metrics to keep traffic in certain parts of the network, but the caller might still desire a latency cutoff, for example. Certain combinations of sorting and pruning might make more sense than others, but keeping the choices flexible allows for more caller preferences to be honored.

### Process

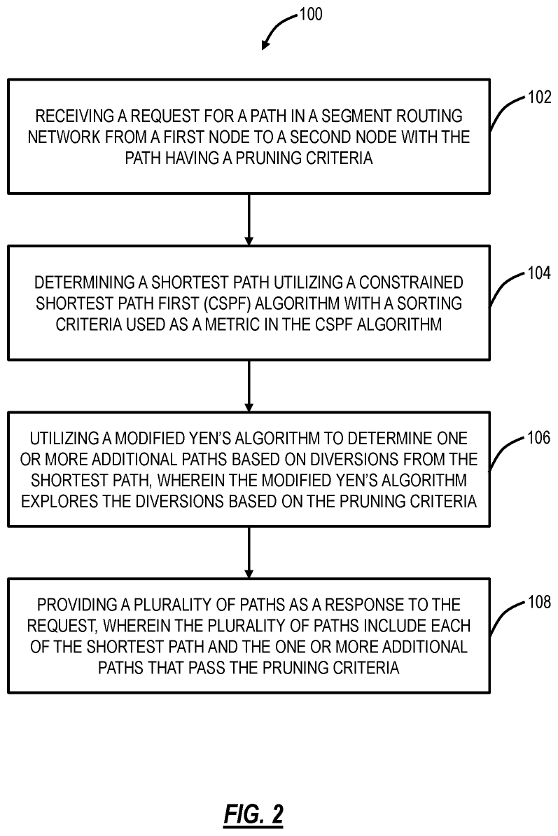

FIG. 2 is a flowchart of a process 100 for a k-shortest paths computation in Segment Routing considering a pruning criteria (e.g., MSD). The process 100 contemplates implementation as a computer-implemented method having steps, via a processing device such as the PCE 30 configured to implement the steps, and as a non-transitory computer-readable medium storing instructions that, when executed, cause one or more processors to implement the steps.

The process 100 includes receiving a request for a path in a Segment Routing network from a first node to a second node with the path having a pruning criteria (step 102); determining a shortest path utilizing a Constrained Shortest Path First (CSPF) algorithm with a sorting criteria used as a metric in the CSPF algorithm (step 104); utilizing a modified Yen's algorithm to determine one or more additional paths based on diversions from the shortest path, wherein the modified Yen's algorithm explores the diversions based on the pruning criteria (step 106); and providing a plurality of paths as a response to the request, wherein the plurality of paths include each of the shortest path and the one or more additional paths that pass the pruning criteria (step 108).

The modified Yen's algorithm can explore the diversions based on the pruning criteria by excluding a root path for a diversion if the root path does not meet the pruning criteria. The modified Yen's algorithm can explore the diversions based on the pruning criteria by (1) excluding a possible path if it extends from a root path that does not meet the pruning criteria, and (2) including another possible path that does not itself meet the pruning criteria if it extends from another root path that does meet the pruning criteria. In particular, if our diversion is too late and the root path does not meet the criteria, we do not want to include any possible paths based off of that root path. But if our diversion is early enough that the root path does meet the criteria, we do want to include possible paths based off of that root path, i.e., the another possible path.

The modified Yen's algorithm can explore the diversions based on the pruning criteria by examining previous paths to find root paths, spur nodes, and spur paths, to combine into a total path; excluding any of the root paths in the examining when a corresponding root path does not meet the pruning criteria; and adding the total path from the examining to a heap based on the sorting criteria.

The pruning criteria can be Maximum Segment Depth (MSD). The providing the shortest path and the one or more additional paths can include providing the shortest path and the one or more additional paths in a sorted order by the sorting criteria while each path passes the pruning criteria.

The first node can be a source, the second node can be an intermediate node, and the request can further include a destination, and the process 100 can further include performing the determining and the utilizing from the second node to the destination, such that there is a first path computation from the source to the intermediate node and a second path computation from the intermediate node to the destination; maintaining a heap to add a path from each of the first path computation and the second path computation based on the pruning criteria.

For breaking the path computation with ordered inclusions, the present disclosure includes.
Break path computation into individual CSPFs
Compute k-shortest paths for individual CSPFs; for each individual CSPF.
   A[0] (in list A) is regular 1-shortest CSPF
      1-shortest CSPF uses metric type from sorting criteria as CSPF computation metric
   List B examines previous paths, finds root paths, spur nodes, and spur paths, combines them into total paths added to heap, pops top path from heap.
      Root paths are validated against pruning criteria, and ignored if they do not pass pruning criteria.
      Heap uses sorting criteria to sort its entries
   A[1 through K] are filled with entries from list B who pass the pruning criteria.
Combine results from individuals CSPFs; for each combination.
   Iterate through both groups of (up to) k paths, adding each combination to the heap
      Each combined path is validated against pruning criteria, and ignored if it does not pass.
      Heap uses sorting algorithm to sort its entries
   Top K entries from heap are placed into A[0 through K].
End result is (up to) k paths, in sorted order, that match CSPF constraints and pass the pruning criteria (i.e., MSD, delay bound, etc.)

### Example Processing Device

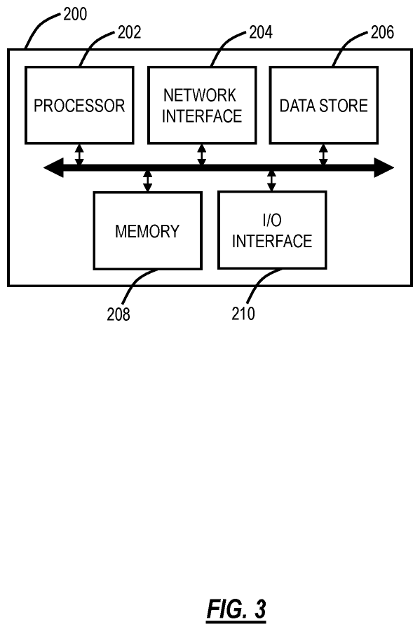

FIG. 3 is a block diagram of an example processing device 200, such as for the PCE 30. The processing device 200 can be part of a network element, or a stand-alone device communicatively coupled to the network element, such as the PCE 30, the SDN controller 20, etc. Also, the processing device 200 can be referred to in implementations as a control module, a shelf controller, a shelf processor, a system controller, etc. The processing device 200 can include a processor 202 which is a hardware device for executing software instructions. The processor 202 can be any custom made or commercially available processor, a central processing unit (CPU), an auxiliary processor among several processors associated with the processing device 200, a semiconductor-based microprocessor (in the form of a microchip or chipset), or generally any device for executing software instructions. When the processing device 200 is in operation, the processor 202 is configured to execute software stored within the memory, to communicate data to and from the memory, and to generally control operations of the processing device 200 pursuant to the software instructions. The processing device 200 can also include a network interface 204, a data store 206, memory 208, an I/O interface 210, and the like, all of which are communicatively coupled to one another and to the processor 202.

The network interface 204 can be used to enable the processing device 200 to communicate on a data communication network, such as to communicate to a management system, or the like. The network interface 204 can include, for example, an Ethernet module. The network interface 204 can include address, control, and/or data connections to enable appropriate communications on the network. The data store 206 can be used to store data, such as control plane information, provisioning data, Operations, Administration, Maintenance, and Provisioning (OAM&P) data, etc. The data store 206 can include any of volatile memory elements (e.g., random access memory (RAM, such as DRAM, SRAM, SDRAM, and the like)), nonvolatile memory elements (e.g., ROM, hard drive, flash drive, CDROM, and the like), and combinations thereof.

Moreover, the data store 206 can incorporate electronic, magnetic, optical, and/or other types of storage media. The memory 208 can include any of volatile memory elements (e.g., random access memory (RAM, such as DRAM, SRAM, SDRAM, etc.)), nonvolatile memory elements (e.g., ROM, hard drive, flash drive, CDROM, etc.), and combinations thereof. Moreover, the memory 208 may incorporate electronic, magnetic, optical, and/or other types of storage media. Note that the memory 208 can have a distributed architecture, where various components are situated remotely from one another, but may be accessed by the processor 202. The I/O interface 210 includes components for the processing device 200 to communicate with other devices.

Note, while the various descriptions relate to the processing device 300 and the PCE 30, those skilled in the art will appreciate a PCE can be located in an SDN controller, in-skin (within) a network element, hosted in the cloud, in a management system, and the like. Also, the present disclosure is not limited to being implemented in the PCE 30, rather any device can perform the various functions described herein.

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including software and/or firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” “a circuit configured to,” “one or more circuits configured to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Further, the various elements, operations, steps, methods, processes, algorithms, functions, techniques, modules, circuits, etc. described herein contemplate use in any and all combinations with one another, including individually as well as combinations of less than all of the various elements, operations, steps, methods, processes, algorithms, functions, techniques, modules, circuits, etc.

What is claimed is:

1. A non-transitory computer-readable medium comprising instructions that, when executed, cause one or more processors to perform steps of:
receiving a request for a path in a Segment Routing network from a first node to a second node with the path having a pruning criteria;
determining a shortest path utilizing a Constrained Shortest Path First (CSPF) algorithm with a sorting criteria used as a metric in the CSPF algorithm;
utilizing a modified Yen's algorithm to determine one or more additional paths based on diversions from the shortest path, wherein the modified Yen's algorithm explores the diversions based on the pruning criteria; and
providing a plurality of paths as a response to the request, wherein the plurality of paths include each of the shortest path and the one or more additional paths that pass the pruning criteria.

2. The non-transitory computer-readable medium of claim 1, wherein the modified Yen's algorithm explores the diversions based on the pruning criteria by excluding a root path for a diversion if the root path does not meet the pruning criteria.

3. The non-transitory computer-readable medium of claim 1, wherein the modified Yen's algorithm explores the diversions based on the pruning criteria by
(1) excluding a possible path if it extends from a root path that does not meet the pruning criteria, and
(2) including another possible path that does not itself meet the pruning criteria if it extends from another root path that does meet the pruning criteria.

4. The non-transitory computer-readable medium of claim 1, wherein the modified Yen's algorithm explores the diversions based on the pruning criteria by
examining previous paths to find root paths, spur nodes, and spur paths, to combine into a total path;
excluding any of the root paths in the examining when a corresponding root path does not meet the pruning criteria; and
adding the total path from the examining to a heap based on the sorting criteria.

5. The non-transitory computer-readable medium of claim 1, wherein the pruning criteria is Maximum Segment Depth (MSD).

6. The non-transitory computer-readable medium of claim 1, wherein the providing the shortest path and the one or more additional paths includes providing the shortest path and the one or more additional paths in a sorted order by the sorting criteria.

7. The non-transitory computer-readable medium of claim 1, wherein the first node is a source, the second node is an intermediate node, and the request further includes a destination, wherein the steps further include
performing the determining and the utilizing from the second node to the destination, such that there is a first path computation from the source to the intermediate node and a second path computation from the intermediate node to the destination; and
maintaining a heap to add a path from each of the first path computation and the second path computation based on the pruning criteria.

8. A method comprising steps of:
receiving a request for a path in a Segment Routing network from a first node to a second node with the path having a pruning criteria;
determining a shortest path utilizing a Constrained Shortest Path First (CSPF) algorithm with a sorting criteria used as a metric in the CSPF algorithm;
utilizing a modified Yen's algorithm to determine one or more additional paths based on diversions from the shortest path, wherein the modified Yen's algorithm explores the diversions based on the pruning criteria; and
providing a plurality of paths as a response to the request, wherein the plurality of paths include each of the shortest path and the one or more additional paths that pass the pruning criteria.

9. The method of claim 8, wherein the modified Yen's algorithm explores the diversions based on the pruning criteria by excluding a root path for a diversion if the root path does not meet the pruning criteria.

10. The method of claim 8, wherein the modified Yen's algorithm explores the diversions based on the pruning criteria by
(1) excluding a possible path if it extends from a root path that does not meet the pruning criteria, and
(2) including another possible path that does not itself meet the pruning criteria if it extends from another root path that does meet the pruning criteria.

11. The method of claim 8, wherein the modified Yen's algorithm explores the diversions based on the pruning criteria by
examining previous paths to find root paths, spur nodes, and spur paths, to combine into a total path;
excluding any of the root paths in the examining when a corresponding root path does not meet the pruning criteria; and
adding the total path from the examining to a heap based on the sorting criteria.

12. The method of claim 8, wherein the pruning criteria is Maximum Segment Depth (MSD).

13. The method of claim 8, wherein the providing the shortest path and the one or more additional paths includes providing the shortest path and the one or more additional paths in a sorted order by the sorting criteria.

14. The method of claim 8, wherein the first node is a source, the second node is an intermediate node, and the request further includes a destination, wherein the steps further include
performing the determining and the utilizing from the second node to the destination, such that there is a first path computation from the source to the intermediate node and a second path computation from the intermediate node to the destination; and
maintaining a heap to add a path from each of the first path computation and the second path computation based on the pruning criteria.

15. A processing device comprising:
one or more processors; and
memory storing instructions that, when executed, cause the one or more processors to
receive a request for a path in a Segment Routing network from a first node to a second node with the path having a pruning criteria,
determine a shortest path utilizing a Constrained Shortest Path First (CSPF) algorithm with a sorting criteria used as a metric in the CSPF algorithm,
utilize a modified Yen's algorithm to determine one or more additional paths based on diversions from the shortest path, wherein the modified Yen's algorithm explores the diversions based on the pruning criteria, and
provide a plurality of paths as a response to the request, wherein the plurality of paths include each of the shortest path and the one or more additional paths that pass the pruning criteria.

16. The processing device of claim 15, wherein the modified Yen's algorithm explores the diversions based on the pruning criteria by excluding a root path for a diversion if the root path does not meet the pruning criteria.

17. The processing device of claim 15, wherein the modified Yen's algorithm explores the diversions based on the pruning criteria by
(1) excluding a possible path if it extends from a root path that does not meet the pruning criteria, and
(2) including another possible path that does not itself meet the pruning criteria if it extends from another root path that does meet the pruning criteria.

18. The processing device of claim 15, wherein the modified Yen's algorithm explores the diversions based on the pruning criteria by
examining previous paths to find root paths, spur nodes, and spur paths, to combine into a total path;
excluding any of the root paths in the examining when a corresponding root path does not meet the pruning criteria; and
adding the total path from the examining to a heap based on the sorting criteria.

19. The processing device of claim 15, wherein the pruning criteria is Maximum Segment Depth (MSD).

20. The processing device of claim 15, wherein the providing the shortest path and the one or more additional paths includes providing the shortest path and the one or more additional paths in a sorted order by the sorting criteria.
